(19) United States
(12) Patent Application Publication
(10) Pub. No.: US 2023/0251843 A1
(43) Pub. Date: Aug. 10, 2023

(54) THE USE OF PROXY COMPONENTS TO ACCESS SOFTWARE COMPONENTS ON A REMOTE COMPUTER

(71) Applicant: Frank LIEU, South Melbourne (AU)

(72) Inventor: Frank LIEU, South Melbourne (AU)

(21) Appl. No.: 18/165,065

(22) Filed: Feb. 6, 2023

(30) Foreign Application Priority Data
Feb. 10, 2022 (AU) 2022900275

(51) Int. Cl. G06F 8/61; G06F 9/451

(52) U.S. Cl. CPC G06F 8/61; G06F 9/452

(57) ABSTRACT

A method of providing a remote computer with access to private software components on a source computer, includes the steps of:
(a) creating proxy software components containing proxy functions corresponding to original functions in the private software components, wherein each proxy function invokes its corresponding original function in the private software component on the source computer via an instant remoting technology;
(b) installing the proxy software components on the remote computer; and
(c) providing the remote computer with instant remoting access to the source computer such that when a proxy function in the proxy software components on the remote computer is invoked, the invocation details are forwarded by the instant remoting technology to the corresponding original function in the private software components on the source computer and the result of the invocation is returned by the same instant remoting technology to the remote computer.

### FIELD OF THE INVENTION

This invention relates to a system and method for allowing the software components on a source computer to be accessed from a remote computer with negligible effort from end users by using proxy components installed on the remote computer. It relates particularly but not exclusively to a system and method for enabling remote software developers to participate in the development of a multi-component software project without the necessity to provide all the components, some which may contain valuable proprietary intellectual property, to the remote developers. This invention also relates particularly but not exclusively to a system and method for, with negligible effort from the end users, allowing a computer software to run on a computer which does not have sufficient hardware capacity to run the software or does not have the licences required by some of the components of the software.

### BACKGROUND TO THE INVENTION

The COVID-19 pandemic brought many significant changes in human behaviour. One of these is a very large increase in the number of people who work remotely, and with it an increase in the number of people who work as freelancers rather than as employees. The use of freelancer programmers over platforms such as Upwork can give companies which develop software several advantages:
1. Employers do not need to pay employee benefits such as superannuation and annual leave. They only pay when they need the freelancers.
2. Talented programmers in developing countries charge a fraction of what is charged by those in developed countries, and they tend voluntarily to work for long hours. This means shorter time to market.
3. There is a much larger pool of talent than the local job market.
4. An employer can leave a rating and review about the quality of the freelancer's work on the freelancer platform. Bad ratings not only look bad, but also cause the freelancer's visibility on the platforms to be reduced. Freelancers thus have a much stronger incentive to achieve excellence than those hired as a conventional walk-in employee.
5. The software team can scale up and down on a weekly basis, offering unprecedented flexibility.
6. Freelancers enjoy a lifestyle in which they have sole control over their time schedule and don't have to be stuck in traffic every day.

However, there is one concern that prevents many companies from hiring international freelancers—the safe-keeping of their intellectual property.

A software application often contains multiple components. Some of them may contain valuable intellectual property. Even if the freelancer works on a component that does not contain valuable intellectual property, he/she needs all of the components on his/her PC for the project to compile and run. This is regarded as an unacceptable risk by many software houses.

### Definitions

In this specification, unless the context requires otherwise, the following definitions apply:
“Computer” includes a network of two or more computers;
“Instant Remoting Technology” is any technology which allows two computers separated by the internet and firewalls to achieve instant communications in which the sender of a message is able to send the message and get the response in a short period of time such as less than a second, preferably without moving on to the next task, including Microsoft Azure Relay or any other similar services offered by other software vendors, and custom designed software to achieve similar results;
“Metadata” means declarative information associated with software components about what services they provide and how to interact with them, including information about the names and input and output parameters of the functions, which helps other software components to interact with them seamlessly;

### SUMMARY OF THE INVENTION

According to a first aspect of the present invention, a method of providing a remote computer with access to private software components on a source computer includes the steps of:
(a) creating proxy software components containing proxy functions corresponding to original functions in the private software components, wherein each proxy function invokes its corresponding original function in the private software component on the source computer via an instant remoting technology;
(b) installing the proxy software components on the remote computer; and
(c) providing the remote computer with instant remoting access to the source computer such that when a proxy function in the proxy software components on the remote computer is invoked, the invocation details are forwarded by the instant remoting technology to the corresponding original function in the private software components on the source computer and the result of the invocation is returned by the same instant remoting technology to the remote computer.

The proxy software components may be created manually, but it is preferred that they be automatically created by a universal proxy generator which analyses metadata of the private software components and automatically creates corresponding proxy components.

The proxy generator preferably creates the proxy software components using the following steps:

reading metadata associated with the private software components;
(ii) identifying in the metadata function names, input parameters and return data parameters for functions;
(iii) generating source code for the proxy components containing a set of proxy functions corresponding to original functions in the private software components, wherein the source code for each proxy function includes instructions to:
   A. generate an invocation data structure containing the names and values of the input parameters of the corresponding original function,
   B. send the invocation data structure, and
   C. return a result of the invocation; and
(iv) compiling the proxy source code to create the proxy software components.

Communication between the remote computer and the source computer may use any suitable type of instant remoting technology and may occur over any suitable infrastructure such as over a direct link, over a private network, or over the Internet. In one suitable configuration, communication occurs over the Internet and is intermediated by a relay server.

The method may further include the preliminary step of installing an instant remoting client on the remote computer and on the source computer, and a remote invocation handler on the source computer, such that an invocation of a proxy function on the remote computer is routed through the remote computer's remoting client through the relay server, then through the source computer's remoting client to the source computer's remote invocation handler, which invokes the corresponding original function in the private software component on the source computer, and a response to the invocation is routed back through the remote invocation handler, the source computer's remoting client, the relay server, and the remote computer's remoting client to the proxy function.

Before generation of the proxy components, particular functions may be designated as cacheable, and, when a cacheable proxy function is called, if a response returned by the corresponding original function has been cached on the remote computer and has not expired, the cached response is returned to the caller of the proxy function so that the invocation is not routed to the source computer; otherwise the corresponding original function in the corresponding private software component on the source computer is called and the returned response is added to the cache.

According to another aspect of the invention, a system enables a remote computer to access private software components on a source computer, the system including:
(a) a source computer;
(b) private software components running on the source computer;
(c) a remote computer;
(d) instant remoting technology communicating between the remote computer and the source computer;
(e) proxy software components installed on the remote computer, wherein the proxy software components contain proxy functions corresponding to original functions in the private software components, and each proxy function invokes its corresponding original function in the private software component on the source computer via the instant remoting technology.

The system preferably further includes a remote invocation handler located on the source computer, wherein the remote invocation handler receives function invocations from the remote computer via the instant remoting technology, directs those function invocations to the corresponding original functions in the private software components, and returns results via the instant remoting technology.

The system preferably further includes a proxy generator which creates the proxy software components by reading metadata associated with the private software components to identify function names, input parameters and return data parameters for functions, and generating code for proxy functions, each of which includes instructions to:
(i) generate an invocation data structure containing the names and values of the input parameters of a corresponding original function.
(ii) send the invocation data structure, and
(iii) return a result of the invocation.

A further aspect of the present invention provides a method for enabling a remote software developer to participate in development of a multi-component software project where an owner does not want to supply all components to the remote developer, the method including:
(a) identifying private software components that the owner does not want to supply to the remote developer;
(b) making the private components available on a source computer;
(c) generating a proxy version of the components to mimic the private components, with proxy components containing proxy functions with names and parameters corresponding to names and parameters of original functions in the private components, each proxy function forwarding an invocations of itself to its corresponding original function in the private software components;
(d) installing the proxy version of the software components on a remote computer operated by the remote software developer; and
(e) providing the remote computer with instant remoting access to the source computer such that invocations of proxy functions in the proxy version of the software components on the remote computer are routed to corresponding original functions on the source computer and results of the invocations are returned to the proxy version of the software components on the remote computer.

According to another aspect of the invention, there is provided a system for enabling a remote software developer to participate in development of a multi-component software project where an owner does not want to supply all components to the remote developer, the system including:
(a) a source computer which hosts private software components that the owner does not want to supply to the remote developer;
(b) proxy software components which contain proxy functions corresponding to original functions in the private software components, each proxy function invoking its corresponding original function in the private software component on the source computer;
(c) instant remoting technology which enables the remote software developer to use the proxy software components to obtain results from functions in the private software components without having actual access to the private software components.

In a further aspect of the present invention, a method for providing computer software to a remote user includes:
(a) separating the computer software into non-private components which will be provided to the user and private components which will not be provided to the user;
(b) making the private components available on a source computer;
(c) applying a proxy generator to the private components, wherein the proxy generator creates a proxy version of the private components containing proxy functions corresponding to original functions in the private components, and each proxy function forwards invocations of itself to its corresponding original function in the private components via an instant remoting technology;
(d) installing the non-private components and the proxy version of the private components of the software on a remote computer operated by the user; and
(e) providing the remote computer with instant remoting access to the source computer such that invocations of proxy functions on the remote computer are routed to their corresponding original functions on the source computer and results of the invocations are returned by the same instant remoting technology to the remote computer.

In another aspect of the present invention, a system for providing computer software to a remote user includes:
(a) a source computer which makes private components of the software available;
(b) a proxy generator which creates a proxy version of the private components containing proxy functions corresponding to original functions in the private components, and each proxy function forwards invocations of itself to its corresponding original function in the private components via an instant remoting technology;
(c) instant remoting technology which enables a remote computer used by the user to use the proxy software components to obtain results from functions in the private software components without having actual access to the private software components.

In a further aspect of the present invention, a method provides computer software to a user who may not have sufficient computing resources to run the software. The method includes:
(a) separating the computer software into non-resource-intensive components and resource-intensive components which may have resource requirements exceeding the capabilities of the user's computer;
(b) making the resource-intensive components available on a source computer which has sufficient resources to run those components;
(c) applying a proxy generator to the resource-intensive components, wherein the proxy generator creates a proxy version of the resource-intensive components containing proxy functions corresponding to original functions in the resource-intensive components, and each proxy function forwards invocations of itself to its corresponding original function in the resource-intensive components via an instant remoting technology;
(d) installing the non-resource-intensive components and the proxy version of the resource-intensive components of the software on a remote computer operated by the user; and
(e) providing the remote computer with instant remoting access to the source computer such that invocations of proxy functions on the remote computer are routed to their corresponding original functions on the source computer and results of the invocations are returned by the same instant remoting technology to the remote computer.

According to a further aspect of the present invention, a system provides computer software to a user who may not have sufficient computing resources to run the software. The system includes:
(a) a source computer which makes resource-intensive components of the software available and has sufficient computing resources to run them;
(b) a proxy generator which creates a proxy version of the resource-intensive components containing proxy functions corresponding to original functions in the resource-intensive components, and each proxy function forwards invocations of itself to its corresponding original function in the resource-intensive components via an instant remoting technology;
(c) instant remoting technology which enables a remote computer used by the user to use the proxy of the resource-intensive components to obtain results from functions in the resource-intensive components on the source computer without having the resource-intensive components installed on the remote computer.

Example embodiments of the invention will now be described in more detail by reference to the drawings. It is to be understood that the particularity of the drawings does not supersede the generality of the preceding description of the invention.

### BRIEF DESCRIPTION OF THE DRAWINGS

FIG. 1 is a high-level schematic view of a method according to an embodiment of the present invention.

FIG. 2 is a more detailed schematic view of a system according to an embodiment of the present invention.

### DETAILED DESCRIPTION

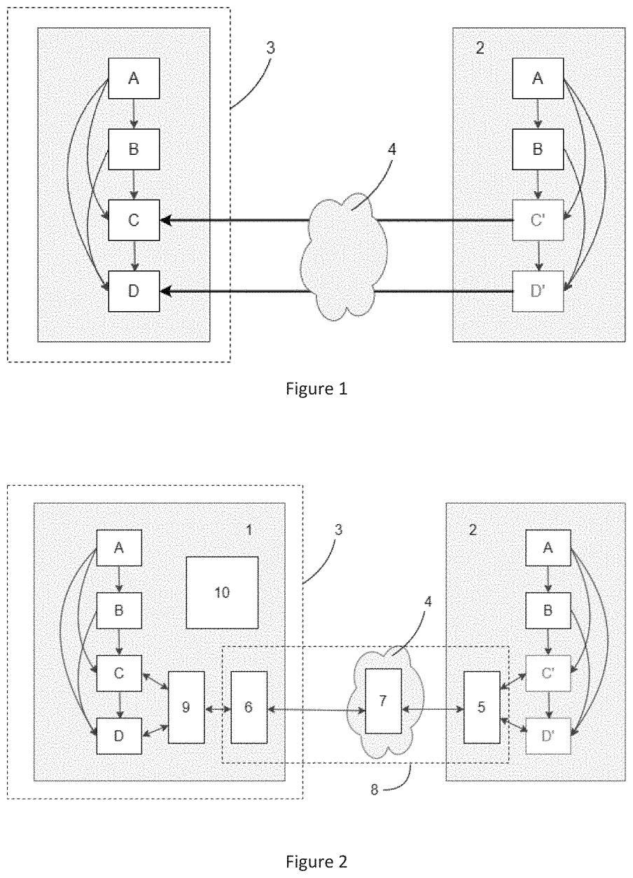

The diagram of FIG. 1 illustrates a situation in which the owner of private software components may need to share those components with another party but where, for reasons of confidentiality or convenience or some other reason the owner wishes not to provide a copy of some of the private software components to the recipient.

The component owner may own any number of software components, but in FIG. 1 these have been arbitrarily illustrated as components A, B, C and D, all held on one or more computers owned by the owner's network or private virtual network 1. Hereafter the one or more computers are collectively referred to interchangeably as network 1 or source computer 1. Components A and B have been arbitrarily illustrated as components which the owner is willing to provide copies to the recipient's remote computer 2, and components C and D have been arbitrarily illustrated as software components which:
1. contain valuable proprietary intellectual property that the owner is not willing to provide copies of to the recipient, or
2. demand a hardware capacity to run which the recipient's computer does not have, or
3. demand certain licences which the recipient does not have.
   There may be other use cases in which this invention can be used.

The component owner's network 1 may be protected by a firewall 3, and remote computer 2 may also be protected by a firewall (not shown).

A method according to the invention of providing access to private software components without actually providing copies of those components includes the step of applying a proxy generator to the private software components C and D. The proxy generator uses the metadata of the private components C and D to automatically produce proxy components C′ and D′ which have the same or similar set of functions as C and D respectively, and each of the said proxy functions forwards any invocations of itself to its corresponding function in the private components C or D on source computer 1. Proxy components C′ and D′ are then installed on remote computer 2. Communications between proxy components C′ or D′ and private components C or D may occur over any suitable infrastructure 4 such as over a direct link, over a private network, or over the Internet.

FIG. 2 shows instant remoting clients 5 on computer 2 and 6 on computer 1, which allow limited communications between the proxy components on remote computer 2 and the private components on source computer 1, so that when an external software process such as software component A or B invokes a function in the proxy components C′ or D′ on remote computer 2, the invocation is routed to the corresponding function in private components C or D on source computer 1 and the result of invoking the function in C or D is returned to the corresponding function in proxy components C′ or D′ on remote computer 2.

As one of possibly many instant remoting technologies, a relay server 7 as illustrated in FIG. 2 is accessible by both source computer 1 and remote computer 2. Both computers establish connections with relay server 7, which relays messages between them. Dotted outline 8 in FIG. 2 represents the instant remoting technology used in conjunction with the invention, exemplified by instant remoting clients 5 and 6 and relay server 7.

Remote invocation handler 9 on source computer 1 acts as middleman between instant remoting client 6 and private software components C and D. When a function invocation is received by instant remoting client 6, handler 9 interprets the invocation and invokes the corresponding function in software component C or D, then assembles the response into an appropriate data format and returns it via instant remoting client 6.

Proxy generator 10 will be described in further detail below.

It will be readily understood that this method enables an owner of software components to provide another party with proxy copies of those components where the proxy copies function by offering the same or similar set of functions, which redirect function calls over the internet to the corresponding functions in the private software components on the owner's private network.

### Software Development Process

A particular application of the invention relating to outsourcing of programming tasks to remote programmers will now be discussed. Software development is typically conducted by dividing the project into multiple components, each providing a number of services. The most popular form of service-providing software components are called dynamic linked libraries (DLL). A DLL is usually produced by human programmers writing source code of the DLL, then the source code is compiled by a compiler to produce the executable form of the DLL.

Each service provided by a DLL is a function. A DLL may contain any number of functions. An external process that invokes a function in the DLL is called a caller. A function has a function name and a number of input parameters, each with a parameter name and data type. Every time the caller invokes a function, it provides the values of such input parameters. A function has an internal process which does something useful with the values of the input parameters, and returns the result to the caller. The process inside the function which does this “something useful” is called the implementation of the function. This “something useful” is the service that this function provides to its callers.

A simple example of a function is an “Addition” function that takes two integer parameters and performs a mathematical addition, and returns the result to the caller.

The callers have no access or visibility to the implementations of the functions in a DLL. The implementations are black boxes to the callers. The returned result of a function call is how the caller knows about the outcome of the invocation.

The details about a DLL that outsiders are able to find out is called the public interface of this DLL. It includes all of its functions' names, each function's input parameters and return data type, plus other information about this DLL such as its software version. The data that contains these details are called the metadata of the DLL. It is part of the DLL and can be retrieved and understood by other software such as software development kits including the popular Microsoft Visual Studio.

Suppose a software development project contains DLL A and B, A invokes the service of B, but B is missing. When a software development kit (SDK) such as Microsoft Visual Studio compiles the project, it will raise errors. When the code in A is executed, the execution will fail. This is why for any software developer to participate in the coding of any component in a software project, all the components must be present on the developer's PC for the SDK to compile and for the application to run.

The present invention allows the software developer to have on his or her computer what appears to the compiler to be a complete set of software components, so that the compiler does not raise any errors. This is because the proxy components have an identical public interface to those of the private components which they replace. However, if someone tried to use a reverse engineering tool to examine the internal source code of the proxy components, they would see only the networking source code generated by the proxy generator, which does nothing but forwarding the invocations to the private components.

### Instant Remoting Server and Clients

Remoting is a technology that allows a software process (the caller) to invoke the service of a software component (the service provider) that is not in the same process. The caller and the service provider can be in two different processes in the same computer, or in two separate computers, even separated by firewalls and Internet.

In the example discussed above with reference to FIG. 2, an experimental setup with source computer 1 located in Australia and remote computer 2 located in India provided a complete invocation-response round trip time of less than half a second. This is sufficiently fast for many purposes. For some applications it may currently be too slow, but developments in remoting technology are resulting in ever-shorter round-trip times, which means that this invention, even if not usable in some use cases presently, will be very likely usable in five or ten years' time.

Computers are most often behind corporate firewalls. For the sake of security, corporate firewalls allow computers inside the firewall to reach out, for example, a browser on an internal PC reaching out to fetch content from an external website, but forbids outsiders to poke into the firewall to reach any internal computer. The only type of computers that allow any computer in the world to reach them are web servers and alike, which are not behind corporate firewalls. Therefore, if two computers are behind different firewalls and want to exchange data instantly without requiring complex changes on their firewalls, one of the solutions is for them to both reach out of their firewalls to establish an instant and two-way connection with a same middleman web server, and the server relays data between the two computers.

This intermediary relay server preferably uses encrypted communications provided, for example, by TLS technology, with each connection between a computer and the server being encrypted using a unique key and salt.

To facilitate the two-way instant data exchange between two computers, a lot of work needs to be done on the two computers in collaboration with the relay server, such as the sender breaking up a large chunk of data into small packets, addressing, sequencing, compressing, encrypting the packets, and the receiver decrypting, decompressing and reassembling the large chunk of data from many packets.

Instant remoting clients as shown as 5 and 6 in FIG. 2 are preferably available to be installed on source computer 1 and remote computer 2, which collaborate with the relay server 7 to provide the instant remoting capability. The original and proxy DLLs (private software components and proxy software components) and the remote invocation handler 9 are thus relieved of all of the complexities. When a function in the proxy DLL is invoked, all it needs to do is to put the name of the function and the names and values of the input parameters into a byte array, then tell the instant remoting client: “Here are some bytes, send them to a computer identified by ‘PC0324’”

“PC0324” is a unique identifier that corresponds to the source computer 1 that contains the original DLLs.

### Proxy Generator

The Proxy Generator is a user interface software application that owners of original DLLs use to generate proxy DLLs from the original DLLs. It generates the source code for a proxy DLL, then compiles the source code to produce the executable proxy DLL. The source code in every function in the proxy DLL invokes the instant remoting client to forward the invocations on to the corresponding function in the original DLL, then gets the response back and returns it to the caller. The same proxy generator is used to generate proxy DLLs from all kinds of original DLLs.

In one possible implementation of the proxy generator, the user clicks a “Select original DLL” button. The app shows a file browser dialog, allowing the user to browse the file system of the source computer to select the original DLL which cannot be given to a third party for various reasons. The proxy generator then reads the metadata of this DLL, and generates a proxy DLL.

After the metadata is read, before the proxy DLL is generated, there is an optional step: the proxy generator takes some user input to decide what functions in the original DLL should be in the proxy DLL. By default, all functions in the original DLL go into the proxy DLL, but the user may decide some functions do not go into the proxy DLL. This decision may be done by user ticking checkboxes on the proxy generator app's user interface, or by the app reading from a separate file which contains the list of functions that do or do not go into the proxy DLL.

Suppose, by way of example, that an original DLL contains two functions:

Function 1:
[Name] Addition
[Input parameters]
   1. [Name] a. [Type] integer
   2. [Name] b. [Type] integer
[Return type] integer
[Internal implementation]
   Perform a mathematical addition, a+b, and return the result as return type.

Function 2:
[Name] Square
[Input parameters]
   1. [Name] a. [Type] integer
[Return type] integer
[Internal implementation]
   Perform a mathematical multiplication, a x a, and return the result as return type.

The generated proxy DLL will also contain two functions:

Function 1:
[Name] Addition
[Input parameters]
   1. [Name] a. [Type] integer
   2 [Name] b. [Type] integer
[Return type] integer
[Internal implementation]
   Suppose this function is called by a caller with input parameter “a” being 123 and “b” being 456, it will assemble the following invocation string and send it via the instant remoting client to the original DLL:
   “<FunctionName>Addition</FunctionName>
   <InputParams>
      <Param Name=“a” Type=“integer”>123</Param>
      <Param Name=“b” Type=“integer”>456</Param>
   </InputParams>”

Function 2:
[Name] Square
[Input parameters]
   1. [Name] a. [Type] integer
[Return type] integer
[Internal implementation]
   Suppose this function is called by a caller with input parameter “a” being 25, it will assemble the following invocation string and send it via the remoting client to the original DLL:
   “<FunctionName>Square</FunctionName>
   <InputParams>
      <Param Name=“a” Type=“integer”>25</Param>
   </InputParams>”

From the above it can be seen that, even if two original DLLs created by two different companies for different purposes are completely different-for example one is to control all aspects of a car engine, the other is to read from an employees database and retrieve all types of information about them—the internal implementations of the functions in the two proxy DLLs will be highly similar. They are only different in the function names, number of input parameters and the names and values of the input parameters of each function.

The proxy DLL generator performs the following functions:
1. Read the metadata of the original DLL. For each function in the metadata, get the function name, number of input parameters, the name of each parameter and the return data type.
2. Generate the source code of the whole proxy DLL, which contains all or a reduced set of the functions and the source code in each function.
3. In each function, the generated code is to assemble the invocation string which contains the names and values of the input parameters and forward it to the original DLL via the instant remoting client, and get back the response from the original DLL and return it to the caller.
4. Compile the generated source code to produce the proxy DLL.

### Caching

In cases where a frequently called function in a DLL returns the same response each time, the response time can be accelerated by caching. Suppose the user interface of a software application needs to call a DLL which contains the following two functions:
1. “GetEmployeeBirthday”: it takes an employee ID as the input parameter, queries the corporate database, and returns the employee's birthday.
2. “GetEmployeeOnlineStatus”: it takes an employee ID and returns the employee's current online status (“offline”, “online”, “busy”, “away”).

Suppose the software company hires a remote developer to develop the user interface. Since this DLL queries the corporate database that cannot be given to the remote programmer, the DLL cannot be given to the remote programmer. A proxy DLL is generated from this DLL and given to the remote developer.

On the remote developer's PC, the user interface invokes this proxy DLL very often. To forward these calls across the Internet to the original DLL on the source computer in the software company, each round trip takes about 0.5 second. The user interface may feel a bit sluggish due to these half-second delays. If we can speed up these calls, the user interface may run faster.

A person's birthday never changes, so when software company's in-house programmer writes the source code of the original DLL, function “GetEmployeeBirthday” is marked to be cached with a “Cache=true” attribute in front of the function in the source code.

The online status of an employee can change at any second, so function “GetEmployeeOnlineStatus” is not to be cached.

When the proxy DLL generator is used to generate the proxy DLL, it sees this “Cache=true” attribute in front of function “GetEmployeeBirthday”, and generates the source code in this function to do caching. Function “GetEmployeeOnlineStatus” does not have this attribute, so the generated source code in this function does not do caching.

When function “GetEmployeeBirthday” in the proxy DLL is called with employee ID “12345” for the first time, it makes the long trip to the original DLL, which queries the corporate database and returns that employee's birthday. The proxy DLL stores this birthday against employee ID “12345” in the cache.

Five seconds later, the same function is called again with the same employee ID “12345”. This time, instead of making the long trip, the function looks up the cache to get the birthday for employee 12345. This call is therefore able to return in one millisecond.

Every time function “GetEmployeeOnlineStatus” in the proxy DLL is called, it always makes the long trip to the original DLL to get the employee's online status.

This way, the owners of software components get to decide which function shall be cached and which shall not. If properly configured, the caching is able to prevent most long trips across the Internet, and therefore allows the proxy DLL to function even more like the original DLL.

### Example of End-to-End Process

This example relates to a software development project in which a software company owns components A, B, C and D, which are stored on source computer 1 as shown in FIG. 2. The software company wishes to outsource part of the development to an international freelancer who uses remote computer 2. Software components C and D contains valuable IP which the software developer does not wish to share with the freelancer.

The end-to-end process of generating the proxy DLLs:
1. The software house appoints a PC of a trusted on-site programmer who participates in the project as the source computer 1 in FIG. 2 which contains the original DLLs C and D and to be remotely invoked by the proxy DLLs.
2. A software package is downloaded onto this source computer, which contains the Proxy DLL generator app 10 and the remote invocation handler 9.
3. Generating the proxy DLLs:
   (1) Using the Proxy DLL generator app, user selects the original DLL C and D using a file explorer-style dialog.
   (2) The app extracts the public metadata of the original DLL (and that of its dependency DLLs if any), and uses the metadata to build the proxy DLL (C′ or D′) within a second.
   (3) The app prompts the user to save the generated proxy DLLs into a location in the local hard drive of his/her choice.
4. The proxy DLL C′ and D′ together with the original component A and B are sent to the freelancer.
5. The freelancer also downloads the instant remoting client onto his PC.
6. The freelancer puts the proxy DLL C′ and D′ in the binary folder of the project, and adds reference to these two DLLs on Visual Studio.
7. When the freelancer compiles his project, it compiles successfully.

When the freelancer runs the project:
1. On the freelancer's PC 2, component A calls function “GetEmployeeBirthday” in proxy DLL C′ with input parameter “EmployeeId” being “12345”.
2. Because this function had been marked as “to be cached”, it checks the local cache if a birthday is being cached for employee ID “12345”.
3. If a cached birthday is found, it is returned to the caller which is component A, and the process ends here.
4. If a cached birthday is not found, this function assembles the following XML string:
   <FunctionName>GetEmployeeBirthday</FunctionName>
   <InputParams>
      <Param Name=″EmployeeId″ Type=″int″>12345</Param>
   </InputParams>
The XML is passed on to instant remoting client 5, together with the address/unique identifier of the destination, which is the software company's source computer 1.
5. Remoting client 5 sends this XML to relay server 7 which identifies the destination address and forwards the message to remoting client 6 on source computer 1 in the software company.
6. Remoting client 6 forwards the message to remote invocation handler 9, which interprets the received XML, and calls function “GetEmployeeBirthday” in the original DLL C with input parameter “EmployeeId” being “12345”.
7. That function returns “23/07/1987” as the birthday to remote invocation handler 9, which assembles it into a suitable return string and passes it to remoting client 6.
8. Remoting client 6 returns the return string to remoting client 5 in the freelancer's PC 2, via relay server 7.
9. Remoting client 5 returns “23/07/1987” to function “GetEmployeeBirthday” in proxy DLL C′.
10. The function returns “23/07/1987” to the caller, which is component A.

### OTHER EMBODIMENTS

In one example embodiment, the method and system of the present invention can be used for allowing the owner of a computer software to supply the software to a recipient for it to be run on the recipient's computer that does not have the conditions required by one of the components that are part of that software. In the following examples, one component in the software called X is the component that requires some conditions that the recipient cannot provide. In the first example, component X conducts intense computation which requires a high-end computer with very expensive CPUs and large memory capacity, but the recipient cannot afford such an expensive computer. In a second example, component X requires an expensive software licence that is issued by a third party, but the recipient does not intend to buy such a licence. In the third example, component X retrieves data from an Oracle database that is hosted on an expensive server, but the recipient's computer on which the software is intended to run does not have access to that server and the recipient cannot afford to buy an expensive server, or cannot afford the Oracle database licence, or the database cannot be supplied to the recipient because it contains privacy or proprietary IP.

Using the method and system of the present invention, the owner of the software hosts component X (which demands some conditions to run which the recipient cannot provide) on their own computer which meets those conditions. A proxy generator is applied to component X to produce a proxy version which has the same set of functions as component X and behaves the same as X because each of the proxy function forwards the invocations on itself to the corresponding function in component X.

Other components in the software that can be hosted on the recipient's computer and the proxy version of component X are then installed on the recipient's computer. Invocations on the functions in the proxy version of component X on the recipient's computer are routed to corresponding functions in component X on the owner's computer and the results of such function invocations are returned to the proxy version of component X on the recipient's computer. The purpose and effect of applying the method and system of the present invention in this example is that the software is able to run on the recipient's computer which does not have the conditions to support component X, because component X is hosted on the owner's computer which does the heavy lifting, while all that the proxy version of component X does is to forward the calls on itself to component X, and such forwarding demands little computation power and no third party licence.

In another example embodiment, the method and system of the present invention can be used to avoid the considerable software development effort needed so that the software process on one computer (hereinafter called the invoking computer) can invoke the functions in a DLL on another computer (hereinafter called the invoked computer), where the two computers are separated by firewalls and Internet.

A DLL can only be invoked by a caller that is in the same process on the same computer as the DLL. To allow a DLL to be invoked from a remote computer without using the present invention, the developers of the software that runs on the two computers have to spend many months to write extra software components that are to be installed on both computers and possibly on the middleman relay server. As soon as the DLL has any change—for example a new function is added or an input parameter of a function is changed, these extra software components need to be changed, retested and re-released.

The method and system of the present invention allows the software developers to generate a proxy DLL from the DLL that is installed on the invoked computer which is to be invoked by the software on the invoking computer. The proxy DLL is installed on the invoking computer. The software on the invoking computer can now invoke this proxy DLL without any extra programming because it is in the same process on the same computer. Under the hood the invocations on the functions in the proxy DLL is routed to the corresponding function in the DLL on the invoked computer. As a result, instead of spending many months to write the extra software to allow the software on the invoking computer to invoke the functions in the DLL on the invoked computer, the software developers only spend minutes to install the proxy generator and use it to generate the proxy DLL.

1. A method of providing a remote computer with access to private software components on a source computer, including the steps of:
(a) creating proxy software components containing proxy functions corresponding to original functions in the private software components, wherein each proxy function invokes its corresponding original function in the private software component on the source computer via an instant remoting technology;
(b) installing the proxy software components on the remote computer; and
(c) providing the remote computer with instant remoting access to the source computer such that when a proxy function in the proxy software components on the remote computer is invoked, the invocation details are forwarded by the instant remoting technology to the corresponding original function in the private software components on the source computer and the result of the invocation is returned by the same instant remoting technology to the remote computer.

2. A method of providing a remote computer with access to private software components on a source computer according to claim 1 wherein the proxy software components are automatically created by a universal proxy generator which analyses metadata of the private software components and automatically creates corresponding proxy components.

3. A method of providing a remote computer with access to private software components on a source computer according to claim 2, wherein the proxy generator creates the proxy software components using the following steps:
(i) reading metadata associated with the private software components;
(ii) identifying in the metadata function names, input parameters and return data parameters for functions;
(iii) generating source code for the proxy components containing a set of proxy functions corresponding to original functions in the private software components, wherein the source code for each proxy function includes instructions to:
A. generate an invocation data structure containing the names and values of the input parameters of the corresponding original function,
B. send the invocation data structure, and
C. return a result of the invocation; and
(iv) compiling the proxy source code to create the proxy software components.

4. A method of providing a remote computer with access to private software components on a source computer according to claim 2, wherein communication between the remote computer and the source computer using the instant remoting technology occurs over the Internet and is intermediated by a relay server.

5. A method of providing a remote computer with access to private software components on a source computer according to claim 4, further including the preliminary step of installing an instant remoting client on the remote computer and on the source computer, and a remote invocation handler on the source computer, such that an invocation of a proxy function on the remote computer is routed through the remote computer's remoting client through the relay server, then through the source computer's remoting client to the source computer's remote invocation handler, which invokes the corresponding original function in the private software component on the source computer, and a response to the invocation is routed back through the remote invocation handler, the source computer's remoting client, the relay server, and the remote computer's remoting client to the proxy function.

6. A method of providing a remote computer with access to private software components on a source computer according to claim 5, wherein, before generation of the proxy components, particular functions are designated as cacheable, and, when a cacheable proxy function is called, if a response returned by the corresponding original function has been cached on the remote computer and has not expired, the cached response is returned to the caller of the proxy function so that the invocation is not routed to the source computer; otherwise the corresponding original function in the corresponding private software component on the source computer is called and the returned response is added to the cache.

7. A system enabling a remote computer to access private software components on a source computer, the system including:
(a) a source computer;
(b) private software components running on the source computer;
(c) a remote computer;
(d) instant remoting technology communicating between the remote computer and the source computer;
(e) proxy software components installed on the remote computer, wherein the proxy software components contain proxy functions corresponding to original functions in the private software components, and each proxy function invokes its corresponding original function in the private software component on the source computer via the instant remoting technology.

8. A system enabling a remote computer to access private software components on a source computer according to claim 7 further including a remote invocation handler located on the source computer, wherein the remote invocation handler receives function invocations from the remote computer via the instant remoting technology, directs those function invocations to the corresponding original functions in the private software components, and returns results via the instant remoting technology.

9. A system enabling a remote computer to access private software components on a source computer according to claim 8 further including a proxy generator which creates the proxy software components by reading metadata associated with the private software components to identify function names, input parameters and return data parameters for functions, and generating code for proxy functions, each of which includes instructions to:
(i) generate an invocation data structure containing the names and values of the input parameters of a corresponding original function.
(ii) send the invocation data structure, and
(iii) return a result of the invocation.

10. A method for enabling a remote software developer to participate in development of a multi-component software project where an owner does not want to supply all components to the remote developer, the method including:
(a) identifying private software components that the owner does not want to supply to the remote developer;
(b) making the private components available on a source computer;
(c) generating a proxy version of the components to mimic the private components, with proxy components containing proxy functions with names and parameters corresponding to names and parameters of original functions in the private components, each proxy function forwarding an invocations of itself to its corresponding original function in the private software components;
(d) installing the proxy version of the software components on a remote computer operated by the remote software developer; and
(e) providing the remote computer with instant remoting access to the source computer such that invocations of proxy functions in the proxy version of the software components on the remote computer are routed to corresponding original functions on the source computer and results of the invocations are returned to the proxy version of the software components on the remote computer.

11. A system for enabling a remote software developer to participate in development of a multi-component software project where an owner does not want to supply all components to the remote developer, the system including:
(a) a source computer which hosts private software components that the owner does not want to supply to the remote developer;
(b) proxy software components which contain proxy functions corresponding to original functions in the private software components, each proxy function invoking its corresponding original function in the private software component on the source computer;
(c) instant remoting technology which enables the remote software developer to use the proxy software components to obtain results from functions in the private software components without having actual access to the private software components.

12. A method for providing computer software to a remote user, the method including:
(a) separating the computer software into non-private components which will be provided to the user and private components which will not be provided to the user;
(b) making the private components available on a source computer;
(c) applying a proxy generator to the private components, wherein the proxy generator creates a proxy version of the private components containing proxy functions corresponding to original functions in the private components, and each proxy function forwards invocations of itself to its corresponding original function in the private components via an instant remoting technology;
(d) installing the non-private components and the proxy version of the private components of the software on a remote computer operated by the user; and
(e) providing the remote computer with instant remoting access to the source computer such that invocations of proxy functions on the remote computer are routed to their corresponding original functions on the source computer and results of the invocations are returned by the same instant remoting technology to the remote computer.

13. A system for providing computer software to a remote user, the system including:
(a) a source computer which makes private components of the software available;
(b) a proxy generator which creates a proxy version of the private components containing proxy functions corresponding to original functions in the private components, and each proxy function forwards invocations of itself to its corresponding original function in the private components via an instant remoting technology;
(c) instant remoting technology which enables a remote computer used by the user to use the proxy software components to obtain results from functions in the private software components without having actual access to the private software components.

14. A method for providing computer software to a user who may not have sufficient computing resources to run the software, the method including:
(a) separating the computer software into non-resource-intensive components and resource-intensive components which may have resource requirements exceeding the capabilities of the user's computer;
(b) making the resource-intensive components available on a source computer which has sufficient resources to run those components;
(c) applying a proxy generator to the resource-intensive components, wherein the proxy generator creates a proxy version of the resource-intensive components containing proxy functions corresponding to original functions in the resource-intensive components, and each proxy function forwards invocations of itself to its corresponding original function in the resource-intensive components via an instant remoting technology;
(d) installing the non-resource-intensive components and the proxy version of the resource-intensive components of the software on a remote computer operated by the user; and
(e) providing the remote computer with instant remoting access to the source computer such that invocations of proxy functions on the remote computer are routed to their corresponding original functions on the source computer and results of the invocations are returned by the same instant remoting technology to the remote computer.

15. A system for providing computer software to a user who may not have sufficient computing resources to run the software, the system including:
(a) a source computer which makes resource-intensive components of the software available and has sufficient computing resources to run them;
(b) a proxy generator which creates a proxy version of the resource-intensive components containing proxy functions corresponding to original functions in the resource-intensive components, and each proxy function forwards invocations of itself to its corresponding original function in the resource-intensive components via an instant remoting technology;
(c) instant remoting technology which enables a remote computer used by the user to use the proxy of the resource-intensive components to obtain results from functions in the resource-intensive components on the source computer without having the resource-intensive components installed on the remote computer.
